(19) United States
(12) Patent Application Publication
(10) Pub. No.: US 2024/0401982 A1
(43) Pub. Date: Dec. 5, 2024

(54) DEVICE FOR MEASURING A LINEAR POSITION

(71) Applicants: SAFRAN LANDING SYSTEMS, VELIZY-VILLACOUBLAY (FR); SAFRAN ELECTRONICS & DEFENSE, Paris (FR)

(72) Inventors: Blaise LAPÔTRE, MOISSY-CRAMAYEL (FR); Rémy HOFF, MOISSY-CRAMAYEL (FR); Thibaut NESTORET, MOISSY-CRAMAYEL (FR); Arnaud GAPIN, MOISSY-CRAMAYEL (FR); Emmanuel COUTURIER, MOISSY-CRAMAYEL (FR)

(73) Assignees: SAFRAN LANDING SYSTEMS, VELIZY-VILLACOUBLAY (FR); SAFRAN ELECTRONICS & DEFENSE, Paris (FR)

(21) Appl. No.: 18/697,851

(22) PCT Filed: Oct. 7, 2022
(86) PCT No.: PCT/EP2022/077900

§ 371 Date: Apr. 2, 2024

(30) Foreign Application Priority Data
Oct. 7, 2021 (FR) FR2110649

(51) Int. Cl. G01D 5/14; B60T 17/22; B64C 25/42; F16D 55/36; F16D 65/18; F16D 66/00

(52) U.S. Cl. CPC G01D 5/145; B60T 17/22; B64C 25/42; F16D 66/00; F16D 55/36; F16D 65/186; F16D 2066/003; F16D 2066/006

(57) ABSTRACT

A measuring device has a magnetic circuit with a first and second armature elements that are positioned one on either side of an axis X and are manufactured with at least one ferromagnetic material. A magnet is situated between the armature elements such that a first pole of the magnet is positioned next to the first armature element and such that a second pole of the magnet is positioned next to the second armature element. A rod is arranged to be secured to a target and inserted between the armature elements to slide along the axis X. The rod has a variable section along its length such that a magnetic flux in the magnetic circuit depends on a linear position of the rod along the axis X. At least one sensor is arranged to measure the magnetic flux, which corresponds to the linear position of the target.

The invention relates to the field of devices for measuring a linear position of a target. Such a device can be implemented to measure the wear of friction discs of an aircraft brake.

### BACKGROUND OF THE INVENTION

The brake of a wheel of an aircraft generally comprises a stack of friction discs, a thrust plate, and controllable actuators to selectively exert a braking force on the thrust plate and therefore on the stack of discs. Such a brake conventionally comprises a wear control formed of a rod which is secured to the thrust plate, and the linear position of which is representative of the wear of the stack of discs. In maintenance, an operator thus verifies the position of the rod to determine the state of wear of the discs.

It is considered to automatically monitor the wear of the stack of discs of a brake by measuring, using a sensor, the linear position of the rod.

A device for measuring the linear position of a target is known, which has a magnetic circuit and a Hall effect cell, and which supplies an output signal which is directly proportional to the distance which separates said device for measuring the target. In this measuring device, the linearity condition of the output signal is only satisfactory when the distance to be measured is sufficiently low, i.e. around a few millimetres. The measuring device is therefore only usable, in this case, for measuring the movements of the target of a few millimetres. Furthermore, the output signal of the measuring device varies between two strictly positive values. Thus, if said signal must be converted from the analogue domain to the digital domain (for example, for processing needs), it will not be possible to utilise the full scale of an analogue-to-digital converter. This has the consequence of limiting the accuracy of the measurement.

Also, a device for measuring a linear position is known, which has a magnetic circuit and at least one magnetic sensor. The measuring device supplies an output signal representative of a movement of a target positioned in the magnetic circuit. With this solution, the output signal of the measuring device varies between a zero value and a maximum value, such that it is possible to utilise the full scale of an analogue-to-digital converter. However, knowing that it is necessary that said target is positioned in the magnetic circuit, said magnetic circuit must have almost the same dimensions as the target. In certain applications, in particular the measuring of wear of the friction discs of an aircraft brake, this necessarily implies that the measuring device is particularly bulky.

Also, a device for measuring the position of a target is known, specifically applied to a brake of an aircraft wheel. The device comprises a magnetic field emitter and a magnetic field detector. The emitter is arranged such that an orientation of the magnetic field develops according to a movement of the target. The magnetic field detector supplies an output signal representative of the orientation of the magnetic field, which therefore makes it possible to measure a movement of the target. The major disadvantage of this solution is that the measuring device mobilises multiple distinct parts, and that it thus has a high production cost.

### AIM OF THE INVENTION

An aim of the invention is to propose a device for measuring a linear position of a target, which is accurate over a wide measuring extent, and which is small and inexpensive.

### SUMMARY OF THE INVENTION

In view of achieving this aim, a device for measuring a linear position of a target is proposed, having:
a magnetic circuit comprising a first armature element and a second armature element, which are positioned one on either side of an axis X and manufactured with at least one ferromagnetic material;
a magnet situated between the first armature element and the second armature element, such that a first pole of the magnet is positioned next to the first armature element, and that a second pole of the magnet is positioned next to the second armature element;
a rod arranged so as to be secured to the target and inserted between the first armature element and the second armature element so as to slide along the axis X, the rod having a variable section along its length, such that a magnetic flux in the magnetic circuit depends on a linear position of the rod along the axis X;
at least one sensor arranged to measure at least one parameter representative of the magnetic flux, and therefore of the linear position of the rod, and therefore of the linear position of the target.

The measuring device according to the invention is particularly advantageous, as it has at least one sensor supplying an output signal varying according to the linear position of the rod, secured in translation to the target. The rod can therefore be adapted, along the length of its useful portion for the measurement, to perform a significant linear movement. For example, in the case of measuring wear of the stack of discs of an aircraft brake, a significant linear movement is a movement greater than 50 mm. Thus, the measuring device according to the invention is capable of supplying an accurate measurement, even when the target performs a significant linear movement.

Furthermore, the measuring device according to the invention has few elements and is therefore very simple, small and inexpensive.

In an embodiment, the rod has a truncated-shaped portion.

In an embodiment, the first armature element and the second armature element each comprises a first portion and a second portion successively defined along an axis Y perpendicular to the axis X, the magnet being positioned between the first portion of the first armature element and the first portion of the second armature element, and the axis X between the second portion of the first armature element and the second portion of the second armature element.

In an embodiment, the second portion of the first armature element and the second portion of the second armature element each have a flat shape.

In an embodiment, the second portion of the first armature element and the second portion of the second armature element each have a semi-cylindrical shape of axis X.

In an embodiment, the first portion of the first armature element and the first portion of the second armature element each have a flat shape.

In an embodiment, the first pole of the magnet is in contact with the first portion of the first armature element, and the second pole of the magnet is in contact with the first portion of the second armature element.

In an embodiment, the ferromagnetic material is an iron and nickel alloy.

In an embodiment, the measuring device has at least one sensor which is a magnetic sensor.

In an embodiment, the magnetic sensor is an analogue Hall effect sensor arranged to measure the magnetic flux.

In an embodiment, the magnetic sensor is a digital Hall effect sensor arranged to measure the magnetic flux.

In an embodiment, the magnetic sensor is positioned between the first armature element and the second armature element, in the proximity of the magnet.

In an embodiment, the magnet is positioned between the rod and the sensor.

In an embodiment, the measuring device has at least one analogue Hall effect sensor which is connected to an analogue electronic circuit having an operational amplifier connected as a subtractor, said analogue electronic circuit being arranged to subtract, to an electric measuring signal supplied by the at least one sensor, an offset voltage in order to utilise a full scale of an analogue-to-digital converter.

In an embodiment, the measuring device has at least one sensor which has a first deformation gauge mounted on the first armature element and a second deformation gauge mounted on the second armature element, each deformation gauge being arranged to measure a deformation of the armature element on which it is mounted.

The invention also relates to a brake of an aircraft wheel comprising a stack of discs, a thrust plate mounted on the stack of friction discs, actuators arranged to apply a braking force on the thrust plate and therefore on the stack of friction discs, and a measuring device such as described above, the target being an external face of the thrust plate.

The invention also relates to an aircraft comprising a wheel and a brake such as described above, said brake being arranged to brake said wheel.

Other features and advantages of the invention will emerge upon reading the description below of particular, non-limiting embodiments of the invention.

### BRIEF DESCRIPTION OF THE DRAWINGS

The description of the invention makes reference to the accompanying drawings, among which:

FIG. 1 represents a raised view of a brake of an aircraft wheel, equipped with a measuring device according to the invention;

FIG. 2 represents a cross-sectional view, along a plane perpendicular to the linear movement of the rod, of a measuring device according to a first particular embodiment of the invention;

FIG. 3 represents a longitudinal, cross-sectional view of the rod of the measuring device illustrated in FIG. 2;

FIG. 4 is a figure similar to FIG. 2, following a linear movement of the rod;

FIG. 5 represents an analogue electronic circuit connected to the magnetic sensor of the measuring device illustrated in FIG. 1;

FIG. 6 illustrates the conditioning produced by the analogue electronic circuit illustrated in FIG. 5;

FIG. 7 represents cross-sectional view, along a plane perpendicular to the linear movement of the rod, of a measuring device according to a second particular embodiment of the invention;

FIG. 8 represents a perspective view of a measuring device according to a third particular embodiment of the invention, as well as simulation results of the magnetic field;

FIG. 9 represents a cross-sectional view, along a plane perpendicular to the linear movement of the rod, of a measuring device according to a fourth particular embodiment of the invention.

### DETAILED DESCRIPTION OF THE INVENTION

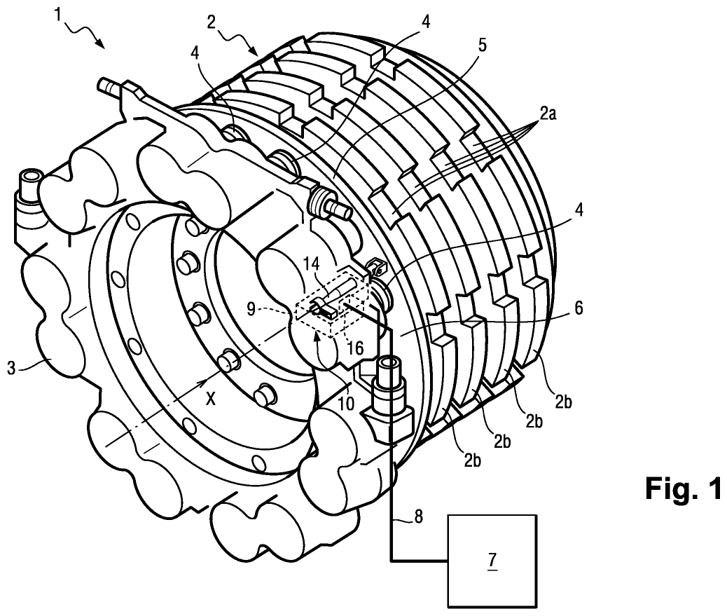

In reference to FIG. 1, the invention is described, in this case, in application to a brake, referenced as 1, of a wheel of a landing gear of an aircraft.

The brake 1 comprises a stack of friction discs 2 (also called heat well) having rotor discs 2a and stator discs 2b alternatively threaded on a torsion tube. The rotor discs 2a are rotatably secured to the wheel and the stator discs 2b are rotatably immovable with respect to the wheel. The discs 2a, 2b are provided with brake trims.

The brake 1 further comprises an actuator support 3, fixed to an end of the torsion tube. The actuator support 3 carries actuators 4 arranged to exert a braking force on a thrust plate 5 mounted on the stack of discs 2. The braking force exerted on the thrust plate 5 is thus distributed evenly on the stack of discs 2. The operation of the brake 1 is known and will therefore not be unduly detailed. It must be noted that the invention can apply to any type of brake (hydromechanical, electromechanical, etc.) intended to brake a wheel of any type of vehicle.

The brake 1 is equipped with a measuring device 10 to determine the wear of the discs 2a, 2b of the stack of discs 2.

The measuring device 10 measures the linear position along an axis X of a target, which is, in this case, the external face 6 of the thrust plate 5, said linear position being representative of the wear of the stack of discs 2 of the brake 1.

The measuring device 10 has a rod 14 mounted sliding through the actuator support 3.

The rod 14 is secured in translation along the axis X of the external face 6 of the thrust plate 5. The rod 14 thus slides along a linear path, in this case along the axis X, as the discs 2a, 2b of the stack of discs 2 wear. Furthermore, the measuring device 10 is connected to a piece of external equipment 7 (computer, data concentrator, etc.), situated, for example, in the hold of the aircraft or on the strut of the landing gear, via a cable 8 or a wireless connection.

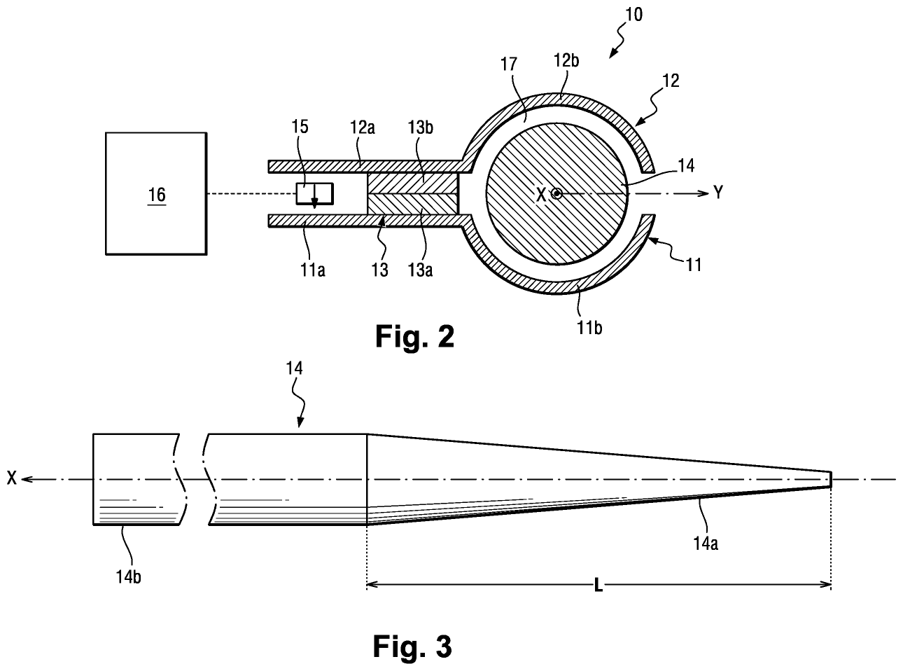

A measuring device according to a first embodiment of the invention 10 is described, in reference to FIG. 2.

The measuring device 10 has:
a magnetic circuit comprising a first armature element 11 and a second armature element 12, positioned one on either side of the axis X and manufactured with at least one ferromagnetic material. In this case, the armature elements 11, 12 are manufactured in an iron and nickel alloy (FeNi).
a magnet 13 situated between the first armature element 11 and the second armature element 12, such that a positive pole 13a (or north pole) of the magnet 13 is positioned next to the first armature element 11, and that a negative pole 13b (or south pole) of the magnet 13 is positioned next to the second armature element 12. More specifically, the positive pole 13a is, in this case, in contact with the first armature element 11 and the negative pole 13b is, in this case, in contact with the second armature element 12. The magnet 13 is a permanent magnet delivering a magnetic field of constant intensity.
the rod 14 which, as has been seen, is secured in translation along the axis X of the target, which is, in this case, the external face 6 of the thrust plate 5. The rod 14 thus slides along the axis X. Advantageously, the rod 14 is manufactured in a material which is resistant to high temperatures (for example, around 150° C.).
a magnetic sensor 15 which is, in this case, a Hall effect sensor to measure the magnetic flux.

The magnetic circuit, the magnet and the magnetic sensor are themselves integrated in a casing 9 fixed on the actuator support 3.

The first armature element 11 has a first portion 11a and a second portion 11b successively defined along an axis Y perpendicular to the axis X.

The first portion 11a is in contact with the positive pole 13a of the magnet 13 and has a flat shape.

The second portion 11b faces the rod 14 and has a semi-cylindrical shape of axis X.

In the same way, the second armature element 12 has a first portion 12a and a second portion 12b successively defined along the axis Y.

The first portion 12a is in contact with the negative pole 13b of the magnet 13 and has a flat shape.

The second portion 12b faces the rod 14 and has a semi-cylindrical shape of axis X.

The second portion 11b of the first armature element 11 and the second portion 12b of the second armature element 12 are thus shaped to mainly surround an axial portion of the rod 14.

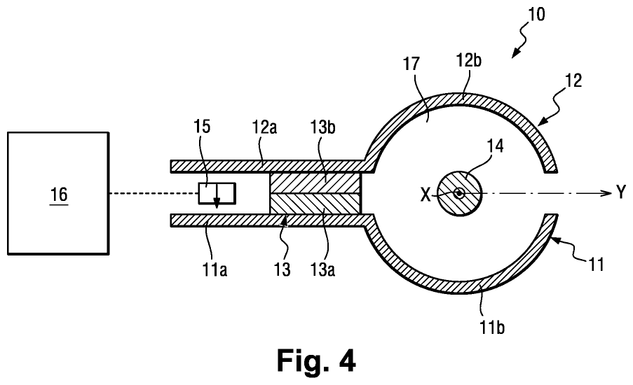

In reference to FIG. 3, the rod 14 has a first portion 14a and a second portion 14b which are successively defined along the axis X.

The first portion 14a has a length L and its section is variable in the direction of the length. In this case, the first portion 14a has a truncated shape. The first portion 14a is the useful portion for measuring.

The second portion 14b has a cylindrical shape and is secured in translation of the external face 6 of the thrust plate 5.

The operation of the measuring device 10 is now described.

According to the wear of the stack of discs 2, the rod 14 will be moved linearly along the axis X inside the cavity 17 delimited by the second portion 11b of the first armature element 11 and by the second portion 12b of the second armature element 12.

As can be seen in FIGS. 2 and 4, the linear movement of the rod 14 will make the section of the axial portion of the rod 14 positioned in the cavity 17 move between the armature elements 11, 12. In this case, the section of the axial portion of the rod 14 positioned between the armature elements 11, 12 decreases with the wear of the stack of discs 2.

Thus, with low wear, the axial portion of the rod situated between the armature elements 11, 12 has a high section (case of FIG. 2), while with high wear, the axial portion of the rod 14 situated between the armature elements 11, 12 has a reduced section (case of FIG. 4).

The magnetic flux in the magnetic circuit will thus vary according to the linear movement of the rod 14. More specifically, the maximum value of the magnetic flux corresponds to the end of the largest section of the first portion 14a of the rod 14 and the minimum value of the magnetic flux corresponds to the end of the smallest section of the first portion 14a of the rod 14.

The magnetic sensor 15 thus makes it possible to measure the magnetic flux and thus supply an output signal representative of the linear movement of the rod 14, therefore of the linear movement of the target, therefore in this case, of the state of wear of the stack of discs 2. The output signal is, in this case, a differential voltage in the case of using an analogue Hall effect sensor. The output signal is a digital value in the case of using a digital Hall effect sensor.

The magnet 13 and the magnetic sensor 15 are positioned between the first portion 11a of the first armature element 11 and the first portion 12a of the second armature element 12.

The magnet 13 and the sensor 15 are, in this case, both positioned on one same plane which is parallel to the axes X and Y.

The sensor 15 faces the first portion 11a of the first armature element 11 and of the first portion 12a of the second armature element 12.

However, it would be possible that the magnetic sensor 15 is situated outside of the space between the armature elements 11, 12.

It is noted that the sensor 15 is positioned in a secondary magnetic flux (not passing through the movable target), which makes it possible to increase the variation range of the induction with respect to the full scale. The sensor is positioned parallel to the magnetisation direction of the magnet.

The magnetic sensor 15 is connected to an electronic unit 16 integrated in the casing 9. The electronic unit 16 comprises, in this case, an electronic board and components mounted on the electronic board, among which conditioning means are located to condition the output signal of the magnetic sensor 15 and an analogue-to-digital converter, in the case of using an analogue Hall effect sensor and communication means, making it possible to transmit the measurements, from the casing 9, to the external equipment 7, via the cable 8 in the case where a wired solution is implemented. The communication means comprise, for example, a digital bus driver, usually of the I²C or SPI type, an RF transmitter, an RFID Tag, etc.

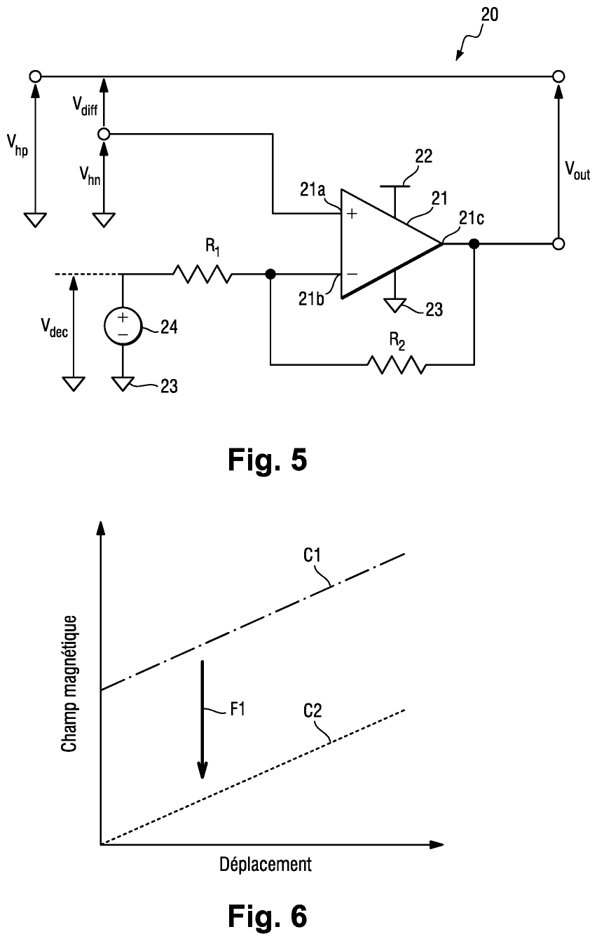

In reference to FIG. 5, the means for conditioning the electronic unit 16 comprise an analogue electronic circuit 20. The analogue electronic circuit 20 comprises an operational amplifier 21 supplied between a supply 22 and an electric ground 23. The supply 22 is conventionally connected to a voltage source supplying an equal direct voltage, for example, at 2.5V. The potential of the electric ground 23 is conventionally a reference 0V.

The operational amplifier 21 has a non-inverter input 21a, an inverter input 21b and an output 21c.

The magnetic sensor 15 has two outputs and supplies a differential output voltage V_{diff} between said two outputs. A first output of the magnetic sensor 15 is such that the voltage between said first output and the electric ground 23 is equal to a voltage Vₕₚ. A second output of the magnetic sensor 15 is such that the voltage between said second output and the electric ground 23 is equal to a voltage Vₕₙ. Furthermore, the voltage V_{diff} is equal to the voltage (Vₕₚ−Vₕₙ)

The non-inverter input 21a of the operational amplifier 21 receives the voltage Vₕₙ supplied by the second output of the magnetic sensor 15.

The inverter input 21b of the operational amplifier 21 is connected to a voltage source, producing a direct offset voltage V_{dec}, via a resistance R₁. In this case, the voltage V_{dec} is the supply voltage of the magnetic sensor 15. For example, the voltage V_{dec} is equal to 1.6V and the resistance R₁ is equal to 3.33 kΩ. Furthermore, the inverter input 21b of the operational amplifier 21 is also connected to the output 21c of said operational amplifier 21 via a resistance R₂. For example, the resistance R₂ is equal to 6.1 kΩ.

The output voltage of the analogue electronic circuit 20 is the voltage Vₒᵤₜ between the first output of the magnetic sensor 15 and the output 21c of the operational amplifier 21.

The operational amplifier 21 is, in this case, connected to the subtractor. The relationship which connects the output voltage Vₒᵤₜ to the voltages Vₕₚ, Vₕₙ and V_{dec} is as follows:

$${V}_{out} = {V}_{hp} - [ ( 1 + \frac{{R}_{2}}{{R}_{1}} ) {V}_{hn} - \frac{{R}_{2}}{{R}_{1}} {V}_{dec} ]$$

The analogue circuit 20 therefore subtracts the voltage V_{dec} multiplied by a gain

$$\frac{{R}_{2}}{{R}_{1}}$$

to the voltage Vₕₙ multiplied by a gain

$$( 1 + \frac{{R}_{2}}{{R}_{1}} ) .$$

It is noted that the measuring device can be supplied by different means, and for example, via the cable 8.

In reference to FIG. 6, an arrow F1 illustrates the conditioning produced by the analogue electronic circuit 20.

The magnetic flux in the vicinity of the measuring device 10 varies between two strictly positive values according to the linear position of the rod 14 (curve C1 in FIG. 6).

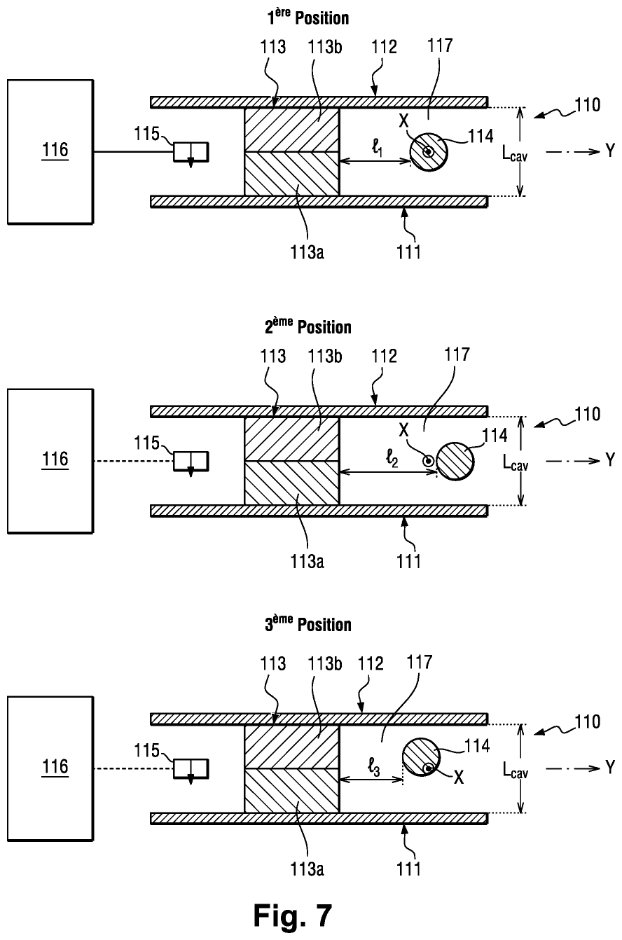

The function of the analogue electronic circuit 20 is therefore to produce the output voltage Vₒᵤₜ, representative of the wear of the stack of discs 2, which itself varies between a zero value and a strictly positive value (curve C2 in FIG. 7). Thus, it is possible to convert said output voltage Vₒᵤₜ of the analogue domain to the digital domain via an analogue-to-digital converter by utilising the full scale of said analogue-to-digital converter (i.e. the range of possible variation of a voltage at the input of said analogue-to-digital converter). This makes it possible to significantly improve the accuracy of the measurement.

A measuring device according to a second embodiment of the invention 110 is described, in reference to FIG. 7.

The second embodiment differs from the first embodiment, in that the measuring device according to a second particular embodiment of the invention 110 has armature elements 111, 112 each having the shape of a plate, the plates being spaced apart by a distance L_{cav}.

FIG. 7 highlights a major advantage of the invention. Indeed, the measuring device 110 (and, in particular, the accuracy of the measurement) is not disrupted by a potential transverse movement of the rod 114 in the cavity 117 delimited by the armature elements 111, 112. For example, the rod can be in the three positions below:
In a first position, the rod 114 can be at a distance l₁ from the magnet 113 and equidistant from the armature elements 111, 112.
In a second position, the rod 114 can be at a distance l₂ from the magnet 113, such that the distance l₂ is greater than the distance l₁. Furthermore, the rod 114 is, in this case, still equidistant from the armature elements 111, 112.
In a third position, the rod 114 can be at a distance l₃ from the magnet 113, such that the distance l₃ is less than the distance l₁. Furthermore, the rod 114 is not necessarily equidistant from the armature elements 111, 112. In this case, the rod 114 is closer to the second armature element 112 than to the first armature element 111.

The magnetic flux in the vicinity of the measuring device 110 actually only depends on the section of the axial portion of the rod 114 positioned in the cavity 117 between the armature elements 111, 112. Thus, even in case of centring defect of the rod 114, the measuring device 110 is capable of supplying an accurate measurement of the linear position of said rod 114, therefore of the linear position of the target.

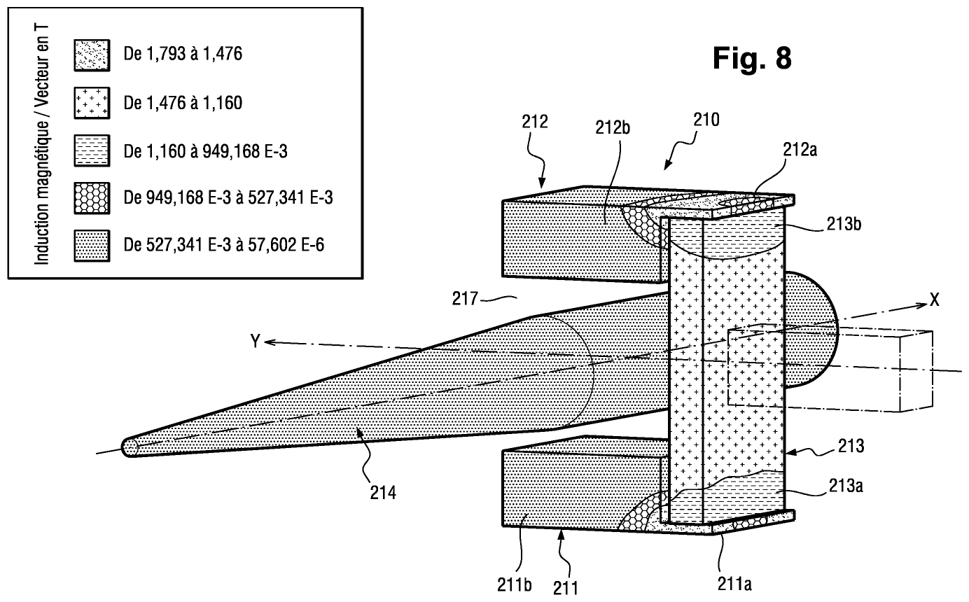

A measuring device according to a third particular embodiment of the invention 210 is described, in reference to FIG. 8.

The first armature element 211 has a first portion 211a and a second portion 211b successively defined along the axis Y. The portions 211a, 211b both have a flat shape. Furthermore, the first portion 211a has a thickness which is significantly thinner than that of the second portion 211b.

In the same way, the second armature element 212 has a first portion 212a and a second portion 212b successively defined along the axis Y. The portions 212a, 212b both have a flat shape. Furthermore, the first portion 212a has a thickness which is significantly thinner than that of the second portion 212b.

The thickness difference between the first portion 211a and the second portion 211b of the first armature element 211, and between the first portion 212a and the second portion 212b of the second armature element 212 creates a reinforcement wherein the magnet 213 is embedded.

Further to the thickness difference described above, the third particular embodiment of the invention is similar to the second embodiment described above.

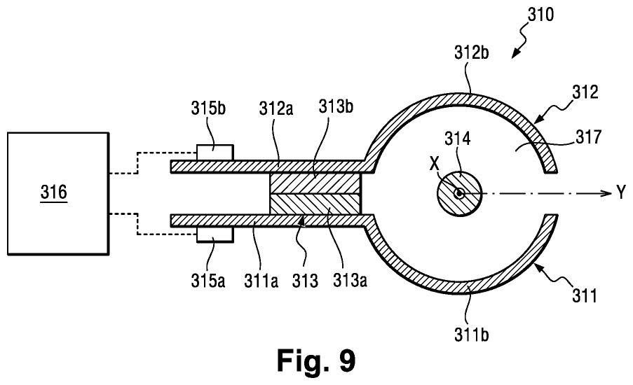

FIG. 9 also shows the spatial distribution of the intensity of the electromagnetic induction (measured in Tesla) on the measuring device 310. The electromagnetic intensity on the measuring device 310 varies between a minimum value equal to 57.602 μT and a maximum value equal to 1.793 T. In order to view the spatial distribution of the intensity of the electromagnetic induction, five intervals of value are distinguished.

The intensity of the electromagnetic induction is maximum, with a value situated between 1.476 T and 1.793 T on a part of the first portion 211a of the first armature element 211 and on a part of the first portion 212a of the second armature element 212.

The intensity of the electromagnetic induction is minimum, with a value situated between 57.602 μT and 527.341 mT, on the rod 14, on a part of the second portion 211b of the first armature element 211 and on a part of the second portion 212b of the second armature element 212.

The intensity of the electromagnetic induction at the end of the positive pole 13a of the magnet 13 and at the end of the negative pole 13b of the magnet 13 is between 949.148 mT and 1.160 T. The intensity of the electromagnetic induction on the magnet 13, excluding ends, is between 1.160 T and 1.476 T.

A measuring device according to a fourth particular embodiment of the invention 310 is described, in reference to FIG. 9.

The fourth embodiment differs from the first embodiment, in that the measuring device 310 has a first deformation gauge 315a and a second deformation gauge 315b (in other words, the measuring device 310 does not have a magnetic sensor).

The deformation gauge 315a is mounted on the first armature element 311. More specifically, the gauge 315a is mounted on the first portion 311a of the first armature element 311.

The deformation gauge 315b is mounted on the second armature element 312. More specifically, the gauge 315b is mounted on the first portion 312a of the second armature element 312.

According to the wear of the stack of discs 2, the rod 314 will be moved linearly along the axis X in the cavity 317 delimited by the second portion 311b of the first armature element 311 and by the second portion 312b of the second armature element 312.

The magnetic flux in the vicinity of the measuring device 310 will thus vary according to the linear movement of the rod 314. Furthermore, the variation of the magnetic flux will also lead to a variation of the force which is exerted on each of the armature elements 311, 312.

The gauge 315a and the gauge 315b will thus respectively measure the deformation (caused by said force) of the first armature element 311 and of the second armature element 312. Thus, the gauge 315a and the gauge 315b will each supply an output signal representative of the linear movement of the rod 314, therefore of the linear movement of the target, therefore, in this case, of the wear of the stack of discs 2. The output signal of each of the gauges 315a, 315b is subsequently conditioned by conditioning means comprised in the electronic unit 316.

The measuring device, according to the different embodiments of the invention described above, is particularly advantageous, as it has at least one sensor (magnetic sensor or deformation gauge) supplying an output signal varying according to the linear position of the rod, secured in translation of the target. The rod can therefore be adapted, according to the length of its useful portion for the measurement, to perform a significant linear movement. For example, in the case of measuring wear of the stack of discs of an aircraft brake, a significant linear movement is a movement greater than 50 mm. Thus, the measuring device according to the invention is capable of supplying an accurate measurement, even when the target performs a significant linear movement. In particular, when the portion of the rod which is useful for measuring has a truncated shape, the output signal of the sensor is directly proportional to the linear position of the rod, therefore to the linear position of the target.

Furthermore, the measuring device according to the invention only has four distinct elements (the two armature elements, the magnet, the rod and the sensor) and is therefore small and inexpensive.

The measuring device according to the invention also has a satisfactory measuring accuracy (i.e. less than 0.5 mm) over a wide temperature range.

Furthermore, the measuring device according to the invention is capable of operating in an environment characterised by a high temperature, for example, a temperature of around 150° C.

Furthermore, the measuring device makes it possible to measure a linear movement of a target without the rod (secured to the target) being in contact with the magnetic circuit (in this case, the armature elements manufactured with at least one ferromagnetic material). The measuring device according to the invention is thus unusable.

Furthermore, the measuring device according to the invention requires little energy to operate, given that it only operates with at least one sensor connected to an electronic unit having at least one analogue electronic circuit of simple conditioning, an analogue-to-digital converter and communication means.

The invention is not limited to the embodiments described, but comprises any variant entering into the field of the invention such as defined by the claims.

In particular, the different embodiments described can be combined freely according to the needs and/or limitations of the application in question.

It is also provided that the sensor can optionally integrate additional elements, in order to respond to mechanical implementation and/or integration limitations. For example, resins, plastics, or also non-magnetic materials.

It is also possible that the sensor is directly integrated in the electronic unit. Furthermore, if the electronic unit comprises an electronic board, it is possible that the sensor is directly mounted (for example, welded) on said electronic unit.

Although, in this case, the rod has a truncated-shaped portion, it is absolutely possible that said portion has another shape. For example, said portion of the rod could have a conic shape or a “staircase” shape, with a step corresponding to the resolution specified for the measuring device.

Although, in this case (see, in particular, FIG. 1), the length of the first and of the second armature element is less than the length of the first portion of the rod which is useful for measuring (i.e. in reference to FIG. 3, than the length L of the first portion 14a of the rod 14), it is possible that said first and second armature elements have a length equal to or greater than the length of said first portion of the rod which is useful for measuring.

Although, in this case, the measuring device according to the invention is presented in application to a brake of an aircraft wheel, the present invention can apply to any system requiring a device for measuring a linear position of a target. The present invention applies, in particular, in systems requiring a device for measuring a linear position of a target needing to have a low cost and needing to operate in a hot environment.

1. A measuring device for measuring a linear position of a target, comprising:
a magnetic circuit comprising a first armature element and a second armature element, positioned one on either side of an axis X and manufactured with at least one ferromagnetic material;
a magnet disposed between the first armature element and the second armature element, such that a first pole of the magnet is positioned next to the first armature element, and that a second pole of the magnet is positioned next to the second armature element;
a rod configured to be secured to the target and inserted between the first armature element and the second armature element to slide along the axis X, the rod having a variable section along its length, such that a magnetic flux in the magnetic circuit depends on a linear position of the rod along the axis X;
at least one sensor configured to measure at least one parameter representative of the magnetic flux, and therefore of the linear position of the rod, and therefore of the linear position of the target;
the first armature element and the second armature element each comprising a first portion and a second portion successively defined along an axis Y perpendicular to the axis X, the magnet and the sensor being positioned between the first portion of the first armature element and the first portion of the second armature element, and the axis X between the second portion of the first armature element and the second portion of the second armature element.

2. The measuring device according to claim 1, wherein the rod has a truncated-shaped portion.

3. The measuring device according to claim 1, wherein the second portion of the first armature element and the second portion of the second armature element each have a flat shape.

4. The measuring device according to claim 1, wherein the second portion of the first armature element and the second portion of the second armature element each have a semi-cylindrical shape of axis X.

5. The measuring device according to claim 1, wherein the first portion of the first armature element and the first portion of the second armature element each have a flat shape.

6. The measuring device according to claim 1, wherein the first pole of the magnet is in contact with the first portion of the first armature element, and the second pole of the magnet is in contact with the first portion of the second armature element.

7. The measuring device according to claim 1, wherein the ferromagnetic material is an iron and nickel alloy.

8. The measuring device according to claim 1, wherein the at least one sensor is a magnetic sensor.

9. The measuring device according to claim 8, wherein the magnetic sensor is an analogue Hall effect sensor arranged to measure the magnetic flux.

10. The measuring device according to claim 8, wherein the magnetic sensor is a digital Hall effect sensor arranged to measure the magnetic flux.

11. The measuring device according to claim 1, wherein the magnet is positioned between the rod and the sensor.

12. The measuring device according to claim 9, wherein the at least one analogue Hall effect sensor is connected to an analogue electronic circuit having an operational amplifier connected as a subtractor, said analogue electronic circuit being arranged to subtract, to an electric measuring signal supplied by the at least one sensor, an offset voltage in order to utilize a full scale of an analogue-to-digital converter.

13. The measuring device according to claim 1, wherein the at least one sensor is a first deformation gauge mounted on the first armature element and a second deformation gauge mounted on the second armature element, each deformation gauge being arranged to measure a deformation of the armature element on which it is mounted.

14. A brake of an aircraft wheel, comprising a stack of friction discs, a thrust plate mounted on the stack of friction discs, actuators configured to apply a braking force on the thrust plate and therefore on the stack of friction discs, and the measuring device according to claim 1, wherein the target is an external face of the thrust plate.

15. An aircraft comprising a wheel and the brake according to claim 14, wherein said brake is arranged to brake said wheel.
